(19) United States
(12) Patent Application Publication
(10) Pub. No.: US 2016/0115074 A1
(43) Pub. Date: Apr. 28, 2016

(54) GLASS PLATE FOR TEMPERING, TEMPERED GLASS PLATE, AND METHOD FOR MANUFACTURING TEMPERED GLASS PLATE

(71) Applicant: NIPPON ELECTRIC GLASS CO., LTD., Otsu-shi, Shiga (JP)

(72) Inventors: Hiroyuki YASUDA, Shiga (JP); Kozo KOBAYASHI, Shiga (JP); Kazuhiro MAMEDA, Shiga (JP)

(21) Appl. No.: 14/889,929

(22) PCT Filed: May 15, 2014
(86) PCT No.: PCT/JP2014/062940

§ 371 Date: Nov. 9, 2015

(30) Foreign Application Priority Data
May 15, 2013 (JP) 2013-102980

(51) Int. Cl. C03C 21/00; C03C 3/093; C03C 3/091

(52) U.S. Cl. CPC C03C 21/002; C03C 3/091; C03C 3/093

(57) ABSTRACT

A glass sheet to be tempered of the present invention is a glass sheet to be tempered having a sheet area of 0.01 m² or more and a sheet thickness of 1.5 mm or less, in which the glass sheet to be tempered has a maximum value of a retardation in an effective surface measured at an interval of 50 mm of 5.0 nm or less.

### TECHNICAL FIELD

The present invention relates to a glass sheet to be tempered and a tempered glass sheet, and more particularly, to a glass sheet to be tempered and a tempered glass sheet suitable for a cover glass of a display device, such as a cellular phone, a digital camera, or a personal digital assistant (PDA).

### BACKGROUND ART

Display devices, such as a cellular phone, a digital camera, a PDA, a touch panel display, and a large-screen television, show a tendency of further prevalence.

Hitherto, in those applications, a resin sheet, such as an acrylic sheet, has been used as a protective member for protecting a display. However, owing to a low Young's modulus of the resin sheet, the resin sheet is liable to bend when a display surface of the display is pushed with a pen, a human finger, or the like. Therefore, the resin sheet causes a display failure through its contact with an internal display in some cases. The resin sheet also involves a problem of being liable to have flaws on its surfaces, resulting in easy reduction of visibility. A solution to those problems is to use a glass sheet as the protective member. The glass sheet for this application is required to, for example, (1) have a high mechanical strength, (2) have a low density and a light weight, (3) be able to be supplied at low cost in a large amount, (4) be excellent in bubble quality, (5) have a high light transmittance in a visible region, and (6) have a high Young's modulus so as not to bend easily when its surface is pushed with a pen, a finger, or the like. In particular, a glass sheet which does not satisfy the requirement (1) cannot serve as the protective member, and hence a tempered glass sheet obtained through ion exchange treatment has been used as the protective member heretofore (see Patent Literatures 1 and 2, and Non Patent Literature 1).

Hitherto, the tempered glass sheet has been produced by so-called “pre-tempering cutting”, which is a method comprising cutting a glass sheet to be tempered so as to have a predetermined shape in advance and then subjecting the resultant to ion exchange treatment. In recent years, so-called “post-tempering cutting”, which is a method comprising subjecting a large glass sheet to be tempered to ion exchange treatment and then cutting the resultant so as to have a predetermined size, has been under consideration. When the post-tempering cutting is performed, there is an advantage in that the manufacturing efficiency of the tempered glass sheet and various devices dramatically improves.

### CITATION LIST

### Patent Literature

Patent Literature 1: JP 2006-83045 A
Patent Literature 2: JP 2011-88763 A

### Non Patent Literature

Non Patent Literature 1: Tetsuro Izumitani et al., “New glass and physical properties thereof,” First edition, Management System Laboratory. Co., Ltd., Aug. 20, 1984, p. 451-498

### SUMMARY OF INVENTION

### Technical Problem

Incidentally, a float method enables large and thin glass sheets to be mass-produced at low cost, and hence the float method is generally used as a method of forming a tempered glass sheet. For example, in Patent Literature 2, there is disclosed a tempered glass sheet, which is formed by the float method, comprising as a glass composition, in terms of mol %, 67% to 75% of SiO₂, 0% to 4% of Al₂O₃, 7% to 15% of Na₂O, 1% to 9% of K₂O, 6% to 14% of MgO, 0% to 1% of CaO, 0% to 1.5% of ZrO₂, 71% to 75% of SiO₂+Al₂O₃, and 12% to 20% of Na₂O+K₂O and having a thickness of 1.5 mm or less.

However, when the glass sheet to be tempered, which is formed by the float method, is subjected to ion exchange treatment, there arises a problem in that the properties and composition in the vicinity of a surface vary between a side brought into contact with a tin bath during a glass manufacturing step, what is called a bottom surface, and an opposite side thereof, what is called a top surface, and the tempered glass sheet is warped toward the top surface side in a convex shape. When the warpage level of the tempered glass sheet is large, the yield of the tempered glass sheet decreases.

On the other hand, when a glass sheet to be tempered is formed by an overflow down-draw method, the differences in properties and composition between the front surface and the back surface can be reduced, and hence the warpage caused by the differences can be reduced. However, even in the case where a glass sheet to be tempered is formed by an overflow down-draw method, when the glass sheet to be tempered is enlarged and/or thinned, a tempered glass sheet may be warped.

This phenomenon is liable to become conspicuous in the case where a large and/or thin glass sheet to be tempered is subjected to ion exchange treatment and then a tempered glass sheet having a predetermined size is obtained.

In view of the above-mentioned circumstances, an object of the present invention is to provide a glass sheet to be tempered, which is capable of reducing a warpage level to the extent possible even in the case of subjecting a large and/or thin glass sheet to be tempered to ion exchange treatment and then obtaining a tempered glass sheet having a predetermined size.

### Solution to Problem

The inventors of the present invention have made extensive investigations, and as a result, have found that the above-mentioned technical object can be achieved by controlling the retardation (product (Δnt) of a refractive index difference (Δn) and a sheet thickness (t)) of a large and thin glass sheet to be tempered within a predetermined range. The finding is proposed as the present invention. Specifically, the inventors of the present invention have focused on the retardation in an effective surface of the glass sheet to be tempered, and have found that warpage is induced when a large retardation is present locally in the effective surface. In other words, the inventors of the present invention have found that this warpage can be alleviated by controlling the retardation to a predetermined value or less in an entire effective surface.

That is, according to one embodiment of the present invention, there is provided a glass sheet to be tempered having a sheet area of 0.01 m² or more and a sheet thickness of 1.5 mm or less, wherein the glass sheet to be tempered has a maximum value of a retardation in an effective surface measured at an interval of 50 mm is 5.0 nm or less. Herein, the “sheet area” refers to an area of a sheet surface excluding an end surface and refers to an area of any one of the front surface and the back surface. The “effective surface” refers to a surface excluding a region of 10 mm on an inner side from an end surface. The “maximum value of a retardation” can be measured with a commercially available birefringence measurement device, and for example, can be measured with a common optical path interferometric gauge using an optical heterodyne method and a birefringence measurement device using a Fourier analysis method, manufactured by Uniopt Co., Ltd.

In one embodiment of the present invention, the glass sheet to be tempered may be subjected to a cutting step after ion exchange treatment or may be subjected to the cutting step before ion exchange treatment. In the case of the latter, it becomes easy to handle the glass sheet to be tempered (tempered glass sheet).

In one embodiment of the present invention, it is preferred that the glass sheet to be tempered be formed by an overflow down-draw method. When the glass sheet to be tempered is formed by the overflow down-draw method, a glass sheet having satisfactory surface quality in an unpolished state can be produced easily, and further, a large and thin glass sheet can be produced easily. As a result, the mechanical strength of the surface of a tempered glass can be increased easily. Further, the differences in properties and composition in the vicinity of each of the front surface and the back surface are likely to be reduced, and thus the warpage caused by the differences can be suppressed easily. Herein, the “overflow down-draw method” refers to a method comprising causing a molten glass to overflow from both sides of a heat-resistant trough-shaped structure, and subjecting the overflowing molten glasses to down-draw downward while the molten glasses are joined at the lower end of the trough-shaped structure, to thereby form a glass sheet.

In one embodiment of the present invention, it is preferred that the glass sheet to be tempered have a content of B₂O₃ in a glass composition of from 0.7 mass % to 15 mass %.

In one embodiment of the present invention, it is preferred that the glass sheet to be tempered have a content of Na₂O in a glass composition of from 1 mass % to 20 mass %.

In one embodiment of the present invention, it is preferred that the glass sheet to be tempered comprise as a glass composition, in terms of mass %, 50% to 80% of SiO₂, 5% to 25% of Al₂O₃, 0.7% to 15% of B₂O₃, 1% to 20% of Na₂O, and 0% to 10% of K₂O. With this, ion exchange performance and denitrification resistance can both be achieved at high levels.

It is preferred that the glass sheet to be tempered have a compressive stress of a compressive stress layer on a surface of 400 MPa or more, and a depth of layer of the compressive stress layer of 15 μm or more, when subjected to ion exchange treatment in a KNO₃ molten salt at 440° C. for 6 hours. Herein, the “compressive stress of a compressive stress layer” and “depth of layer of a compressive stress layer” refer to values calculated on the basis of the number of interference fringes observed when a sample is observed using a surface stress meter (for example, “FSM-6000” manufactured by Orihara Industrial Co., Ltd.) and intervals therebetween. It should be noted that, in one embodiment of the present invention, it is also preferred that the glass sheet to be tempered have a compressive stress of a compressive stress layer on a surface of 400 MPa or more, and a depth of layer of the compressive stress layer of 15 μm or more, when subjected to ion exchange treatment in a KNO₃ molten salt at from 370° C. to 470° C. for from 2 hours to 8 hours.

In one embodiment of the present invention, it is preferred that the glass sheet to be tempered have an unpolished surface. With this, the productivity of the tempered glass improves, and the mechanical strength of the surface can be increased easily.

In one embodiment of the present invention, it is preferred that the glass sheet to be tempered be used for a cover glass of a display device.

According to one embodiment of the present invention, there is provided a tempered glass sheet, which is produced by subjecting a glass sheet to be tempered to ion exchange treatment, wherein the glass sheet to be tempered comprises the above-mentioned glass sheet to be tempered.

### BRIEF DESCRIPTION OF DRAWINGS

FIG. 1 is a diagram for showing measurement data on a retardation of an original sheet of Sample No. 1 in the section of [Examples].

FIG. 2 is a diagram for showing measurement data on a retardation of an original sheet of Sample No. 2 in the section of [Examples].

FIG. 3 is a diagram for showing data on warpage levels of pieces of Sample No. 1 in the section of [Examples].

FIG. 4 is a diagram for showing data on warpage levels of pieces of Sample No. 2 in the section of [Examples].

### DESCRIPTION OF EMBODIMENTS

In a glass sheet to be tempered of the present invention, the sheet area is 0.01 m² or more, preferably 0.1 m² or more, 0.25 m² or more, 0.35 m² or more, 0.45 m² or more, 0.8 m² or more, 1.2 m² or more, 1.5 m² or more, 2 m² or more, 1.2.5 m² or more, 3 m² or more, 3.5 m² or more, 4 m² or more, or 4.5 m² or more, particularly preferably from 5 m² to 10 m². As the sheet area is larger, the number of pieces to be taken from a tempered glass sheet by post-tempering cutting increases, and the manufacturing efficiency of the tempered glass sheet and various devices dramatically improves. It should be noted that, as the sheet area is larger, the tempered glass sheet is liable to be warped, and hence the effect of the present invention can be exhibited more easily.

The sheet thickness is preferably 1.5 mm or less, 1.0 mm or less, 0.8 mm or less, 0.7 mm or less, or 0.6 mm or less, particularly preferably 0.5 mm or less. With this, the weight of a display device can be reduced easily, and in the case of performing post-tempering cutting, a compressive stress is likely to be generated in a cut surface due to the influence of a compressive stress layer on a surface, with the result that the mechanical strength of the cut surface is less liable to decrease. On the other hand, when the sheet thickness is too small, desired mechanical strength is not obtained easily. Further, the tempered glass sheet is liable to be warped. Thus, the sheet thickness is preferably 0.1 mm or more. It should be noted that, as the sheet thickness is smaller, the tempered glass sheet is liable to be warped, and hence the effect of the present invention can be exhibited more easily.

In the glass sheet to be tempered of the present invention, the maximum value of a retardation in an effective surface measured at an interval of 50 mm is 5.0 nm or less, preferably 4.0 nm or less, 3.5 nm or less, 3.0 nm or less, 2.5 nm or less, or 2.0 nm or less, particularly preferably from 0.1 nm to 1.5 nm. When the maximum value of the retardation is too large, the tempered glass sheet is liable to be warped after ion exchange treatment, and the manufacturing efficiency of the tempered glass sheet is liable to lower. In particular, the post-tempering cutting cannot be performed properly. In the case where the sheet thickness is 0.5 mm or less, the maximum value of the retardation is preferably 1.8 nm or less, 1.5 nm or less, or 1.2 nm or less, particularly preferably from 0.1 nm to less than 1.0 nm. In the case where the sheet thickness is from more than 0.5 mm to 0.6 mm, the maximum value of the retardation is preferably 2.2 nm or less, 1.9 nm or less, or 1.7 nm or less, particularly preferably from 0.1 nm to 1.5 nm. In the case where the sheet thickness is from more than 0.6 mm to 1.0 mm, the maximum value of the retardation is preferably 4.0 nm or less, 3.5 nm or less, 3.0 nm or less, 2.5 nm or less, or 2.0 nm or less, particularly preferably from 0.1 nm to 1.5 nm.

In order to decrease the retardation of the glass sheet to be tempered, for example, when a molten glass is formed into a glass ribbon in a forming furnace (forming trough), it is sufficient that the molten glass be formed into a glass ribbon so as to reduce the difference between the thickness of an end portion of the glass ribbon and the thickness of a center portion thereof to the extent possible, and when the glass ribbon is annealed (cooled) in an annealing furnace, it is sufficient that the temperature distribution in a width direction of the glass ribbon be reduced to the extent possible.

The reason for forming the molten glass into the glass ribbon so as to reduce the difference between the thickness of the end portion of the glass ribbon and the thickness of the center portion thereof to the extent possible in the forming step is as described below. When the thickness of the end portion of the glass ribbon is significantly different from the thickness of the center portion of the glass ribbon, the cooling speed varies between the end portion and the center portion of the glass ribbon in a cooling step after forming, with the result that the retardation in the effective surface increases. For example, when the rotation speed or the like of a forming roll or the like for down-drawing the molten glass into the glass ribbon is adjusted, the thickness of the end portion of the glass ribbon and the thickness of the center portion thereof are made uniform easily.

Further, as a method of reducing the temperature distribution in the width direction of the glass ribbon to the extent possible during the cooling step in the annealing furnace, there are given the following methods.

(1) The number of heaters is increased so that the glass ribbon is heated uniformly.

(2) A soaking plate is set between the heater and the glass ribbon so that heat from the heater is uniformly transmitted to the glass ribbon.

(3) An enclosure is set in the end portion of the glass ribbon, and a large number of heaters are arranged in that portion so that the difference in cooling speed between the center portion and the end portion of the glass ribbon is reduced.

(4) The drawing speed of a glass is decreased (made slow).

Unlike a float method, according to an overflow down-draw method, a low-temperature air flow rises constantly along a surface of the glass ribbon in a direction from the cutting step in a low-temperature atmosphere to the annealing furnace and the forming furnace in a high-temperature atmosphere, and the low-temperature air flow that has risen is heated in the annealing furnace or the like. Then, a part of the air flow leaks to an external atmosphere through a gap of a peripheral wall portion, and hence the atmosphere temperature of the annealing furnace and the forming furnace is liable to change. As a result, in a glass sheet formed by the overflow down-draw method, the retardation in the effective surface is liable to increase. Therefore, in the case of forming a glass sheet by the overflow down-draw method, it is preferred to suppress the rise of the low-temperature air flow in the annealing furnace and the forming furnace, in addition to adjusting the thickness of the end portion of the glass ribbon to be substantially the same as that of the center portion thereof and reducing the temperature distribution.

In order to suppress the rise of the low-temperature air flow in the annealing furnace and the forming furnace, it is sufficient to make it difficult for the air in the forming furnace and the annealing furnace to leak to the external atmosphere, for example, by providing a convection preventing plate in the annealing furnace and performing adjustment so as to increase the atmospheric pressure of the external atmosphere of the forming furnace and the annealing furnace through use of an air-sender or the like.

Besides the above-mentioned methods, it is also effective to decrease the retardation of the glass sheet to be tempered by increasing the contents of SiO₂, Al₂O₃, and B₂O₃ in a glass composition so as to lower a thermal expansion coefficient and increasing the content of an alkaline earth metal oxide so as to decrease an optical elastic constant.

In the glass sheet to be tempered of the present invention, it is preferred that the content of B₂O₃ in the glass composition be from 0.7 mass % to 15 mass %. B₂O₃ is a component that lowers the viscosity at high temperature and the density, and stabilizes a glass to make it difficult for a crystal to deposit and lowers the liquidus temperature. Further, B₂O₃ is a component that increases crack resistance. Further, B₂O₃ is a component that lowers the thermal expansion coefficient to decrease the retardation. However, when the content of B₂O₃ is too large, there are tendencies that the coloring of a surface called weathering occurs due to ion exchange treatment, water resistance lowers, the compressive stress of the compressive stress layer lowers, and the depth of layer of the compressive stress layer lowers.

In the glass sheet to be tempered of the present invention, it is preferred that the content of Na₂O in the glass composition be from 1 mass % to 20 mass % of Na₂O in the glass composition. Na₂O is a main ion exchange component, and is also a component that lowers the viscosity at high temperature to increase meltability and formability. Further, Na₂O is a component that improves denitrification resistance. However, when the content of Na₂O is too small, the meltability lowers, the thermal expansion coefficient becomes low, and the ion exchange performance is liable to lower. On the other hand, when the content of Na₂O is too large, the thermal expansion coefficient becomes too high, with the result that the thermal shock resistance lowers and it becomes difficult to match the thermal expansion coefficient with those of peripheral materials. Further, in some cases, the strain point excessively lowers, and the glass composition loses its component balance, with the result that the denitrification resistance lowers contrarily.

It is preferred that the glass sheet to be tempered comprise as a glass composition, in terms of mass %, 50% to 80% of SiO₂, 5% to 25% of Al₂O₃, 0.7% to 15% of B₂O₃, 1% to 20% of Na₂O, and 0% to 10% of K₂O. The reason why the content range of each component is limited as described above is described below. It should be noted that the expression “%” refers to “mass %” in the following description of the content range of each component.

SiO₂ is a component that forms a network of a glass, and is also a component that lowers the thermal expansion coefficient to decrease the retardation. The content of SiO₂ is preferably from 50% to 80%, from 52% to 75%, or from 55% to 72%, from 55% to 70%, particularly preferably from 55% to 67.5%. When the content of SiO₂ is too small, vitrification does not occur easily. Further, the thermal expansion coefficient becomes too high, and the retardation is liable to increase. On the other hand, when the content of SiO₂ is too large, the meltability and formability are liable to lower. It should be noted that, in the case of prioritizing the decrease in retardation, the content of SiO₂ is preferably larger. Specifically, the content of SiO₂ is preferably 55% or more, 58.4% or more, 59% or more, 59.5% or more, or 60% or more, particularly preferably 60.5% or more.

Al₂O₃ is a component that increases the ion exchange performance, and is also a component that increases a strain point and a Young's modulus. Further, Al₂O₃ is a component that lowers the thermal expansion coefficient to decrease the retardation. The content of Al₂O₃ is preferably from 5% to 25%. When the content of Al₂O₃ is too small, the thermal expansion coefficient becomes too high, and the retardation is liable to increase. In addition, sufficient ion exchange performance may not be exhibited. Thus, the content of Al₂O₃ is preferably 7% or more, 8% or more, 10% or more, 12% or more, 14% or more, or 15% or more, particularly preferably 16% or more. On the other hand, when the content of Al₂O₃ is too large, a devitrified crystal is liable to deposit in the glass and it becomes difficult to forma glass sheet by the overflow down-draw method. Further, the thermal expansion coefficient becomes too low, with the result that it becomes difficult to match the thermal expansion coefficient with those of peripheral materials. In addition, the viscosity at high temperature rises, and the meltability is liable to lower. Thus, the content of Al₂O₃ is preferably 22% or less, 20% or less, 19% or less, or 18% or less, particularly preferably 17% or less. It should be noted that, in the case of prioritizing the decrease in retardation, the content of Al₂O₃ is preferably larger, and specifically, the content of Al₂O₃ is preferably 14% or more, 15% or more, 16% or more, 17% or more, 18% or more, or 19% or more, particularly preferably 20% or more.

B₂O₃ is a component that lowers the viscosity at high temperature and the density, and stabilizes a glass to make it difficult for a crystal to deposit and lowers the liquidus temperature. Further, B₂O₃ is a component that increases crack resistance. Further, B₂O₃ is a component that lowers the thermal expansion coefficient to decrease the retardation. However, when the content of B₂O₃ is too large, there are tendencies that the coloring of a surface called weathering occurs due to ion exchange treatment, water resistance lowers, the compressive stress of the compressive stress layer lowers, and the depth of layer of the compressive stress layer lowers. Thus, the content of B₂O₃ is preferably from 0.7% to 15%, from 1% to 10%, from more than 1% to 8%, or from 1.5% to 6%, particularly preferably from 2% to 5%.

Na₂O is a main ion exchange component, and is also a component that lowers the viscosity at high temperature to increase the meltability and the formability. Further, Na₂O is also a component that improves the denitrification resistance. The content of Na₂O is preferably from 1% to 20%. When the content of Na₂O is too small, the meltability lowers, the thermal expansion coefficient becomes low, and the ion exchange performance is liable to lower. Thus, in the case of introducing Na₂O, the content of Na₂O is preferably 10% or more, or 11% or more, particularly preferably 12% or more. On the other hand, when the content of Na₂O is too large, the thermal expansion coefficient becomes too high, with the result that the thermal shock resistance lowers and it becomes difficult to match the thermal expansion coefficient with those of peripheral materials. Further, in some cases, the strain point excessively lowers, and the glass composition loses its component balance, with the result that the devitrification resistance lowers contrarily. Thus, the content of Na₂O is preferably 17% or less, particularly preferably 16% or less.

K₂O is a component that promotes ion exchange, and has a high effect of increasing the depth of layer of the compressive stress layer among alkali metal oxides. Further, K₂O is a component that lowers the viscosity at high temperature to increase the meltability and the formability. K₂O is also a component that improves the devitrification resistance. The content of K₂O is from 0% to 10%. When the content of K₂O is too large, the thermal expansion coefficient becomes too high, with the result that the thermal shock resistance lowers and it becomes difficult to match the thermal expansion coefficient with those of peripheral materials. Further, there are tendencies that the strain point excessively lowers, and the glass composition loses its component balance, with the result that the devitrification resistance lowers contrarily. Thus, the content of K₂O is preferably 8% or less, 6% or less, or 4% or less, particularly preferably less than 2%.

In addition to the components described above, for example, the following components may be added.

Li₂O is an ion exchange component, and is also a component that lowers the viscosity at high temperature to increase the meltability and the formability. Further, Li₂O is a component that increases the Young's modulus. Further, Li₂O has a high effect of increasing the compressive stress among alkali metal oxides. However, when the content of Li₂O is too large, the liquidus viscosity lowers and the glass is liable to be devitrified. Further, the thermal expansion coefficient becomes too high, with the result that the thermal shock resistance lowers and it becomes difficult to match the thermal expansion coefficient with those of peripheral materials. Further, when the viscosity at low temperature excessively lowers and stress relaxation easily occurs, the compressive stress may lower contrarily. Therefore, the content of Li₂O is preferably from 0% to 3.5%, from 0% to 2%, from 0% to 1%, or from 0% to 0.5%, particularly preferably from 0.01% to 0.2%

The content of Li₂O+Na₂O+K₂O is suitably from 5% to 25%, from 10% to 22%, or from 15% to 22%, particularly suitably from 17% to 22%. When the content of Li₂O+Na₂O+K₂O is too small, the ion exchange performance and the meltability are liable to lower. On the other hand, when the content of Li₂O+Na₂O+K₂O is too large, the glass is liable to be devitrified. In addition, the thermal expansion coefficient becomes too high, with the result that the thermal shock resistance lowers and it becomes difficult to match the thermal expansion coefficient with those of peripheral materials. Further, the strain point excessively lowers, and a high compressive stress is not obtained easily in some cases. Further, the viscosity around the liquidus temperature lowers, and it becomes difficult to secure a high liquidus viscosity in some cases. It should be noted that “Li₂O+Na₂O+K₂O” is the total content of Li₂O, Na₂O, and K₂O.

MgO is a component that lowers the viscosity at high temperature to increase the meltability and the formability, or to increase the strain point and the Young's modulus, and has a high effect of increasing the ion exchange performance among alkaline earth metal oxides. Further, MgO is a component that lowers the optical elastic constant. However, when the content of MgO becomes too large, the density and the thermal expansion coefficient are liable increase, and the glass is liable to be devitrified. Thus, the content of MgO is preferably 12% or less, 10% or less, 8% or less, or 5% or less, particularly preferably 4% or less. It should be noted that, in the case where MgO is introduced into the glass composition, the content of MgO is preferably 0.1% or more, 0.5% or more, or 1% or more, particularly preferably 2% or more.

CaO has a high effect of lowering the viscosity at high temperature to increase the meltability and the formability or to increase the strain point and the Young's modulus, without lowering the denitrification resistance as compared to the other components. Further, CaO is a component that lowers the optical elastic constant. The content of CaO is preferably from 0% to 10%. However, when the content of CaO is too large, the density and the thermal expansion coefficient increase, the glass composition loses its component balance, with the result that the glass is liable to be devitrified contrarily, and the ion exchange performance is liable to lower. Thus, the content of CaO is suitably from 0% to 5%, from 0.01% to 4%, or from 0.1% to 3%, particularly suitably from 1% to 2.5%.

SrO is a component that lowers the viscosity at high temperature to increase the meltability and the formability, or to increase the strain point and the Young's modulus, without lowering the devitrification resistance. Further, SrO is a component that lowers the optical elastic constant. However, when the content of SrO is too large, the density and the thermal expansion coefficient increase, the ion exchange performance lowers, and the glass composition loses its component balance, with the result that the glass is liable to be devitrified contrarily. The content range of SrO is suitably from 0% to 5%, from 0% to 3%, or from 0% to 1%, particularly suitably from 0% to less than 0.1%.

BaO is a component that lowers the viscosity at high temperature to increase the meltability and the formability, or to increase the strain point and the Young's modulus, without lowering the devitrification resistance. Further, BaO is a component that lowers the optical elastic constant. However, when the content of BaO is too large, the density and the thermal expansion coefficient increase, the ion exchange performance lowers, and the glass composition loses its component balance, with the result that the glass is liable to be devitrified contrarily. The content range of BaO is suitably from 0% to 5%, from 0% to 3%, or from 0% to 1%, particularly suitably from 0% to less than 0.1%.

ZnO is a component that increases the ion exchange performance, and in particular, is a component that has a high effect of increasing the compressive stress. Further, ZnO is a component that lowers the viscosity at high temperature without lowering the viscosity at low temperature. However, when the content of ZnO is too large, there are tendencies that the glass manifests phase separation, the devitrification resistance lowers, the density increases, and the depth of layer of the compressive stress layer lowers. Thus, the content of ZnO is preferably from 0% to 6%, from 0% to 5%, from 0% to 1%, or from 0% to 0.5%, particularly preferably from 0% to less than 0.1%.

ZrO₂ is a component that remarkably increases the ion exchange performance, and is also a component that increases the viscosity around the liquidus viscosity and the strain point. However, when the content of ZrO₂ is too large, the devitrification resistance may remarkably lower, and the density may excessively increase. Thus, the content of ZrO₂ is preferably 10% or less, 8% or less, or 6% or less, particularly preferably 5% or less. It should be noted that, in the case where it is intended to increase the ion exchange performance, it is preferred that ZrO₂ be introduced into the glass composition, and in this case, the content of ZrO₂ is preferably 0.01% or more, or 0.5% or more, particularly preferably 1% or more.

P₂O₅ is a component that increases the ion exchange performance, and in particular, is a component that increases the depth of layer of the compressive stress layer. However, when the content of P₂O₅ is too large, the glass is liable to manifest phase separation. Thus, the content of P₂O₅ is preferably 10% or less, 8% or less, 6% or less, 4% or less, 2% or less, or 1% or less, particularly preferably less than 0.1%.

As a fining agent, one kind or two or more kinds selected from the group consisting of As₂O₃, Sb₂O₃, SnO₂, F, Cl, and SO₃ (preferably the group consisting of SnO₂, Cl, and SO₃) may be introduced in an amount of from 0 ppm to 30,000 ppm (3%). From the viewpoint of exhibiting the fining effect reliably, the content of SnO₂+SO+Cl is preferably from 0 ppm to 10,000 ppm, from 50 ppm to 5,000 ppm, from 80 ppm to 4,000 ppm, or from 100 ppm to 3,000 ppm, particularly preferably from 300 ppm to 3,000 ppm. Herein, the “SnO₂+SO+Cl” refers to the total content of SnO₂, SO₃, and Cl.

The content range of SnO₂ is suitably from 0 ppm to 10,000 ppm, or from 0 ppm to 7,000 ppm, particularly suitably from 50 ppm to 6,000 ppm. The content range of Cl is suitably from 0 ppm to 1,500 ppm, from 0 ppm to 1,200 ppm, from 0 ppm to 800 ppm, or from 0 ppm to 500 ppm, particularly suitably from 50 ppm to 300 ppm. The content range of SO₃ is suitably from 0 ppm to 1,000 ppm, or from 0 ppm to 800 ppm, particularly suitably from 10 ppm to 500 ppm.

Rare earth oxides, such as Nd₂O₃ and La₂O₃, are components that increase the Young's modulus, and are also components that can control the color of the glass by being decolored when a color serving as a complementary color is added thereto. However, the cost of the raw material itself is high, and when the rare earth oxides are introduced in large amounts, the denitrification resistance is liable to lower. Therefore, the content of the rare earth oxides is preferably 4% or less, 3% or less, 2% or less, or 1% or less, particularly preferably 0.5% or less.

In the present invention, from the viewpoint of the environment, it is preferred that the contents of As₂O₃, F, PbO, and Bi₂O₃ be substantially zero. Herein, the “content of As₂O₃ is substantially zero” is intended to mean that As₂O₃ is not added actively as a glass component but the case of mixing As₂O₃ at an impurity level is allowed, and specifically refers to that the content of As₂O₃ is less than 500 ppm. The “content of F is substantially zero” is intended to mean that F is not added actively as a glass component but the case of mixing F at an impurity level is allowed, and specifically refers to that the content of F is less than 500 ppm. The “content of PbO is substantially zero” is intended to mean that PbO is not added actively as a glass component but the case of mixing PbO at an impurity level is allowed, and specifically refers to that the content of PbO is less than 500 ppm. The “content of Bi₂O₃ is substantially zero” is intended to mean that Bi₂O₃ is not added actively as a glass component but the case of mixing Bi₂O₃ at an impurity level is allowed, and specifically refers to that the content of Bi₂O₃ is less than 500 ppm.

It is preferred that the glass sheet to be tempered of the present invention have the following characteristics.

The density of the glass to be tempered is preferably 2.6 g/cm³ or less, particularly preferably 2.55 g/cm³ or less. As the density becomes smaller, the weight of the glass sheet to be tempered can be reduced more. It should be noted that the density is easily reduced by increasing the content of SiO₂, B₂O₃, or P₂O₅ in the glass composition or by reducing the content of an alkali metal oxide, an alkaline earth metal oxide, ZnO, ZrO₂, or TiO₂ in the glass composition. It should be noted that the “density” may be measured by a well-known Archimedes method.

The thermal expansion coefficient of the glass to be tempered is preferably 80×10⁻⁷/° C. to 120×10⁻⁷/° C., from 85×10⁻⁷/° C. to 110×10⁻⁷/° C., or from 90×10⁻⁷/° C. to 110×10⁻⁷/° C., particularly preferably from 90×10⁻⁷/° C. to 105×10⁻⁷/° C. When the thermal expansion coefficient is controlled within the above-mentioned ranges, it becomes easy to match the thermal expansion coefficient with those of members made of a metal, an organic adhesive, and the like, and the members made of a metal, an organic adhesive, and the like are easily prevented from being peeled off. Further, as the thermal expansion coefficient becomes lower, the retardation easily becomes smaller. Herein, the “thermal expansion coefficient” refers to a value obtained through measurement of an average thermal expansion coefficient in the temperature range of from 30° C. to 380° C. with a dilatometer. It should be noted that the thermal expansion coefficient is easily increased by increasing the content of SiO₂, Al₂O₃, B₂O₃, an alkali metal oxide, or an alkaline earth metal oxide in the glass composition, and in contrast, the thermal expansion coefficient is easily decreased by reducing the content of the alkali metal oxide or the alkaline earth metal oxide.

The strain point of the glass to be tempered is preferably 500° C. or more, 520° C. or more, or 530° C. or more, particularly preferably 550° C. or more. As the strain point becomes higher, the heat resistance is improved more, and in the case where the tempered glass sheet is subjected to heat treatment after being subjected to ion exchange treatment, the compressive stress layer hardly undergoes elimination. Further, a high-quality film can be easily formed in patterning to form a touch panel sensor or the like. Herein, the “strain point” refers to a value measured based on a method of ASTM C336. It should be noted that the strain point is easily increased by increasing the content of an alkaline earth metal oxide, Al₂O₂, ZrO₂, or P₂O₅ in the glass composition or by reducing the content of an alkali metal oxide in the glass composition.

The temperature at 10^{4.0} dPa·s of the glass to be tempered is preferably 1,280° C. or less, 1,230° C. or less, 1,200° C. or less, or 1,180° C. or less, particularly preferably 1,160° C. or less. Herein, the “temperature at 10^{4.0} dPa·s” refers to a value obtained by measurement using a platinum sphere pull up method. As the temperature at 10^{4.0} dPa·s becomes lower, a burden on forming equipment is reduced more, the forming equipment has a longer life, and consequently, the manufacturing cost of the glass sheet to be tempered is more likely to be reduced. It should be noted that the temperature at 10^{4.0} dPa·s is easily decreased by increasing the content of an alkali metal oxide, an alkaline earth metal oxide, ZnO, B₂O₃, or TiO₂ or by reducing the content of SiO₂ or Al₂O₃.

The temperature at 10^{2.5} dPa·s of the glass to be tempered is preferably 1,620° C. or less, 1,550° C. or less, 1,530° C. or less, or 1,500° C. or less, particularly preferably 1,450° C. or less. Herein, the “temperature at 10^{2.5} dPa·s” refers to a value obtained by measurement using a platinum sphere pull up method. As the temperature at 10^{2.5} dPa·s becomes lower, melting at lower temperature can be carried out, and hence a burden on glass manufacturing equipment such as a melting furnace is reduced more, and the bubble quality is easily improved more. Thus, as the temperature at 10^{2.5} dPa·s becomes lower, the manufacturing cost of the glass sheet to be tempered is more likely to be reduced. It should be noted that the temperature at 10^{2.5} dPa·s corresponds to a melting temperature. Further, the temperature at 10^{2.5} dPa·s is easily decreased by increasing the content of an alkali metal oxide, an alkaline earth metal oxide, ZnO, B₂O₃, or TiO₂ in the glass composition or by reducing the content of SiO₂ or Al₂O₃ in the glass composition.

The liquidus temperature of the glass to be tempered is preferably 1,200° C. or less, 1,150° C. or less, 1,100° C. or less, 1,050° C. or less, 1,000° C. or less, 950° C. or less, or 900° C. or less, particularly preferably 880° C. or less. Herein, the “liquidus temperature” refers to a temperature at which crystals deposit when glass powder which has passed through a standard 30-mesh sieve (sieve opening: 500 μm) and remained on a 50-mesh sieve (sieve opening: 300 μm) is placed in a platinum boat and kept in a gradient heating furnace for 24 hours. It should be noted that as the liquidus temperature becomes lower, the devitrification resistance and the formability are improved more. Further, the liquidus temperature is easily decreased by increasing the content of Na₂O, K₂O, or B₂O₃ in the glass composition or by reducing the content of Al₂O₃, Li₂O, MgO, ZnO, TiO₂, or ZrO₂ in the glass composition.

The liquidus viscosity of the glass to be tempered is preferably 10^{4.0} dPa·s or more, 10^{4.4} dPa·s or more, 10^{4.8} dPa·s or more, 10^{5.0} dPa·s or more, 10^{5.4} dPa·s or more, 10^{5.6} dPa·s or more, 10^{6.0} dPa·s or more, or 10^{6.2} dPa·s or more, particularly preferably 10^{6.3} dPa·s or more. Herein, the “liquidus viscosity” refers to a value obtained through measurement of a viscosity at the liquidus temperature by a platinum sphere pull up method. It should be noted that as the liquidus viscosity becomes higher, the devitrification resistance and the formability are improved more. Further, the liquidus viscosity is easily increased by increasing the content of Na₂O or K₂O in the glass composition or by reducing the content of Al₂O₃, Li₂O, MgO, ZnO, TiO₂, or ZrO₂ in the glass composition.

It is preferred that the glass sheet to be tempered of the present invention have an unpolished surface, and it is particularly preferred that both of the surfaces be unpolished. In addition, the average surface roughness (Ra) of the unpolished surface of the tempered glass sheet is preferably 10 Å or less, more preferably 5 Å or less, more preferably 4 Å or less, still more preferably 3 Å or less, most preferably 2 Å or less. It should be noted that the average surface roughness (Ra) may be measured by a method in conformity with SEMI D7-97 “FPD Glass Substrate Surface Roughness Measurement Method.” Glass originally has extremely high theoretical strength, but often breaks even under a stress far lower than the theoretical strength. This is because a small flaw called a Griffith flaw is generated in a glass surface in a step after forming, such as a polishing step. Therefore, when the surface of the glass sheet to be tempered is left unpolished, the mechanical strength of the tempered glass sheet is maintained after the ion exchange treatment and the tempered glass sheet hardly undergoes breakage. In addition, in the case of performing scribe cutting after the ion exchange treatment, when the surface is left unpolished, an improper crack, breakage, or the like is hardly generated at the time of the scribe cutting. Further, when the surface of the glass sheet to be tempered is left unpolished, the polishing step can be omitted, and hence the manufacturing cost of the glass sheet to be tempered can be reduced. It should be noted that, in order to obtain the unpolished surface, it is recommended to form the glass sheet by an overflow down-draw method.

The glass sheet to be tempered of the present invention is preferably formed by an overflow down-draw method. With this, a glass sheet having satisfactory surface quality in an unpolished state can be formed easily, and consequently, the mechanical strength of the surface of the tempered glass sheet can be increased easily. This is because in the case of the overflow down-draw method, a surface that is to serve as a surface of a glass sheet is formed in a state of a free surface without being brought into contact with a trough-shaped refractory. The structure and material of the trough-shaped structure are not particularly limited as long as desired dimensions and surface quality can be achieved. In addition, a method of applying a force to a glass ribbon in order to down-draw the glass ribbon downward is not particularly limited as long as desired dimensions and surface quality can be achieved. For example, there may be adopted a method comprising rotating a heat-resistant roll having a sufficiently large width in the state of being in contact with the glass ribbon, to thereby draw the glass ribbon, or there may be adopted a method comprising bringing a plurality of paired heat-resistant rolls into contact with only the vicinity of the end surfaces of the glass ribbon, to thereby draw the glass ribbon.

The glass sheet to be tempered of the present invention may be formed by a method other than the overflow down-draw method, such as a slot down-draw method, a float method, a roll-out method, or a re-draw method.

A tempered glass sheet of the present invention is a tempered glass sheet obtained by subjecting a glass sheet to be tempered to ion exchange treatment, in which the glass sheet to be tempered is the above-mentioned glass sheet to be tempered. The tempered glass sheet of the present invention has technical features (for example, a glass composition and glass characteristics) of the glass sheet to be tempered of the present invention. Herein, the descriptions of the repeated technical features are omitted for convenience.

The tempered glass sheet of the present invention has a compressive stress layer formed by ion exchange treatment on a surface thereof. The ion exchange treatment is a method comprising introducing alkali ions having a large ion radius into a glass surface at a temperature equal to or less than the strain point of the glass. When a compressive stress layer is formed by ion exchange treatment, the compressive stress layer can be formed properly even in the case where a sheet thickness is small.

Anion exchange solution, anion exchange temperature, and an ion exchange time may be determined in consideration of, for example, the viscosity characteristics of the glass. In particular, when K ions in a potassium nitrate solution are subjected to ion exchange treatment with Na components in the glass sheet to be tempered, the compressive stress layer can be efficiently formed on the surface.

In the tempered glass sheet of the present invention, the compressive stress of the compressive stress layer is preferably 400 MPa or more, 500 MPa or more, 600 MPa or more, or 700 MPa or more, particularly preferably 800 MPa or more. As the compressive stress is larger, the mechanical strength of the tempered glass sheet increases. On the other hand, when the compressive stress is too large, the internal tensile stress becomes excessively large, with the result that the tempered glass sheet is liable to be subjected to spontaneous breakage, and it becomes difficult to subject the tempered glass sheet to scribe cutting. Thus, the compressive stress of the compressive stress layer is preferably 1,500 MPa or less, particularly preferably 1,300 MPa or less. It should be noted that, when the contents of Al₂O₃, TiO₂, ZrO₂, MgO, and ZnO in the glass composition are increased, and the contents of SrO and BaO are decreased, the compressive stress tends to increase. Further, when the ion exchange time is shortened, and the temperature of the ion exchange solution is decreased, the compressive stress tends to increase.

The depth of layer is preferably 15 μm or more, or 20 μm or more, particularly preferably 25 μm or more. As the depth of layer is larger, the tempered glass sheet is less liable to be cracked even when the tempered glass sheet has deep flaws, and the variation in mechanical strength decreases. On the other hand, when the depth of layer is too large, the internal tensile stress becomes excessively large, with the result that the tempered glass sheet is liable to be subjected to spontaneous breakage, and it becomes difficult to subject the tempered glass sheet to scribe cutting. The depth of layer is preferably 100 μm or less, less than 80 μm, or 60 μm or less, particularly preferably less than 50 μm. It should be noted that, when the contents of K₂O and P₂O₅ in the glass composition are increased, and the contents of SrO and BaO are decreased, the depth of layer tends to increase. Further, when the ion exchange time is extended, and the temperature of the ion exchange solution is increased, the depth of layer tends to increase.

It is preferred that the tempered glass sheet of the present invention be subjected to post-tempering cutting, particularly post-tempering scribe cutting be performed. In the case where the tempered glass sheet is subjected to scribe cutting, it is preferred that the depth of a scribe line be larger than a depth of layer, and an internal tensile stress be 120 MPa or less (desirably 100 MPa or less, 80 MPa or less, 70 MPa or less, 60 MPa or less, or 50 MPa or less). Further, it is preferred that scribing be started from a region which is away from an end surface of the tempered glass sheet to an inner side by 5 mm or more, and it is preferred that the scribing be ended in a region which is away from an opposing end surface to the inner side by 5 mm or more. With this, unintended cracks are less liable to occur during the scribing, and the post-tempering scribe cutting can be easily performed properly. Herein, the internal tensile stress is a value calculated by the following equation.

Internal tensile stress=(Compressive stress×Depth of layer)/(Thickness of tempered glass sheet−Depth of layer×2)

In the case where the post-tempering scribe cutting is performed, it is preferred that a scribe line be formed on a surface of the tempered glass sheet, and the tempered glass sheet be divided along the scribe line. With this, unintended cracks are less liable to develop during the cutting. In order to divide the tempered glass sheet along the scribe line, it is important that the tempered glass be not subjected to spontaneous breakage during formation of the scribe line. The spontaneous breakage is a phenomenon in which the tempered glass sheet is spontaneously broken in the case of receiving damage deeper than the depth of layer due to the influences of the compressive stress in the surface of the tempered glass sheet and the internal tensile stress. When the spontaneous breakage of the tempered glass sheet starts during formation of the scribe line, it becomes difficult to perform desired cutting. Therefore, it is preferred that the depth of the scribe line be controlled within 10 times, 5 times, or particularly 3 times as large as the depth of layer. It should be noted that, in order to form the scribe line, it is preferred to use a diamond wheel tip or the like from the viewpoint of workability.

In the case of performing the post-tempering cutting, it is preferred that a part or a whole of an edge region, in which the end surface (cut surface) and the surface of the tempered glass sheet cross each other, be chamfered, and it is preferred that a part or a whole of the edge region at least on a display side be chamfered. As chamfering processing, R chamfering is preferred, and in this case, R chamfering with a radius of curvature of from 0.05 mm to 0.5 mm is preferred. Further, C chamfering with a radius of curvature of from 0.05 mm to 0.5 mm is also preferred. Further, the surface roughness Ra of a chamfered surface is preferably 1 nm or less, 0.7 nm or less, or 0.5 nm or less, particularly preferably 0.3 nm or less. With this, cracks originating from the edge region can be prevented easily. Herein, the “surface roughness Ra” refers to a value measured by a method in conformity with JIS B0601:2001.

### Example 1

The present invention is hereinafter described in detail with reference to Examples. It should be noted that the following Examples are merely illustrative. The present invention is by no means limited to the following Examples.

Example (Sample No. 1) and Comparative Example (Sample No. 2) of the present invention are shown in Table 1.

TABLE 1

| | | No. 1 | | No. 2 | |
|---|---|---|---|---|---|
| Sheet area | | 640 mm × 740 mm | | 640 mm × 740 mm | |
| Sheet thickness | | 0.7 | mm | 0.7 | mm |
| Maximum value of | | 1.5 | nm | 5.2 | nm |
| retardation in | | | | | |
| effective surface | | | | | |
| Warpage level | Before | 0.029 | mm | 0.043 | mm |
| Original sheet | tempering | | | | |
| | treatment | | | | |

| | | | |
|---|---|---|---|
| Warpage level | Before | 0.02% | 0.03% |
| Piece | tempering | | |
| | treatment | | |
| | After | 0.08% | 0.14% |
| | tempering | | |
| | treatment | | |

| | | | | |
|---|---|---|---|---|
| Compressive stress | 712 | MPa | 706 | MPa |
| Depth of layer | 44 | μm | 45 | μm |

Sample No. 1 and Sample No. 2 were produced as described below. First, glass raw materials were blended to produce a glass batch. Next, the glass batch was loaded into a continuous melting furnace and formed into a sheet shape having a thickness of 0.7 mm by an overflow down-draw method after a fining step, a stirring step, and a supply step. Then, the resultant was cut into predetermined dimensions (640 mm×750 mm) to produce glass sheets to be tempered (original sheets). Each of the glass sheets to be tempered comprises as a glass composition, in terms of mass %, 57.4% of SiO₂, 13% of Al₂O₃, 2% of B₂O₃, 2% of MgO, 2% of CaO, 0.1% of Li₂O, 14.5% of Na₂O, 5% of K₂O, and 4% of ZrO₂, and has a density of 2.54 g/cm³, a strain point of 517° C., a thermal expansion coefficient of 99.9×10⁻⁷/° C., a temperature at 10^{4.0} dPa·s of 1,098° C., a temperature at 10^{2.5} dPa·s of 1,392° C., a liquidus temperature of 880° C., and a liquidus viscosity of 10^{5.5} dPa·s. In addition, the glass sheets to be tempered each have an unpolished surface. It should be noted that the maximum value of a retardation in an effective surface was adjusted by controlling the forming condition (rotation speed of a forming roll, drawing speed) and the annealing condition (degree of rise of a low-temperature air flow) of the overflow down-draw method.

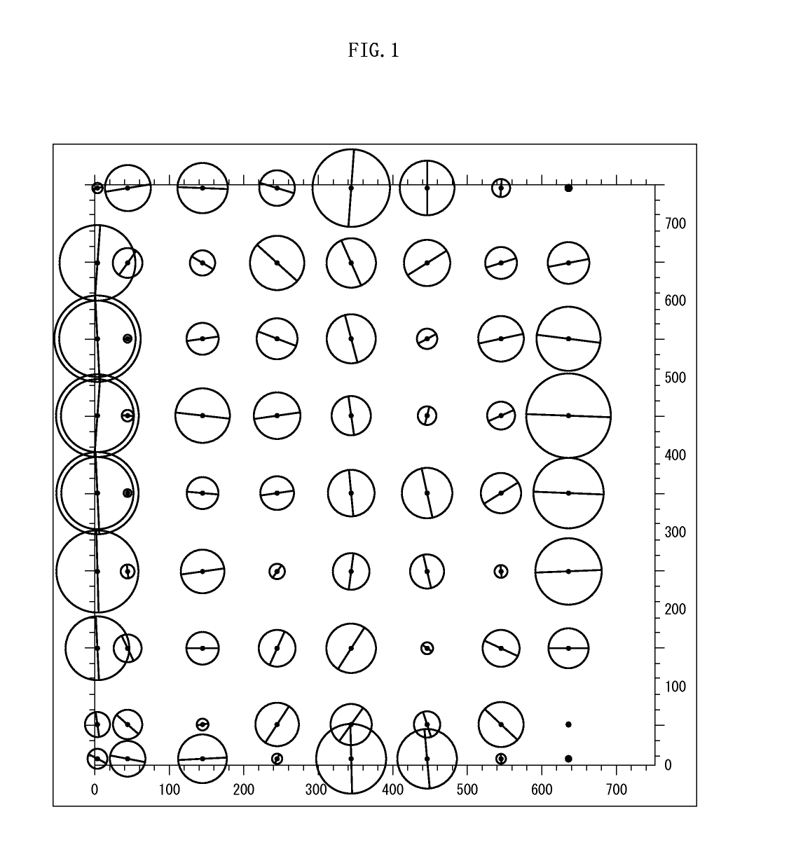

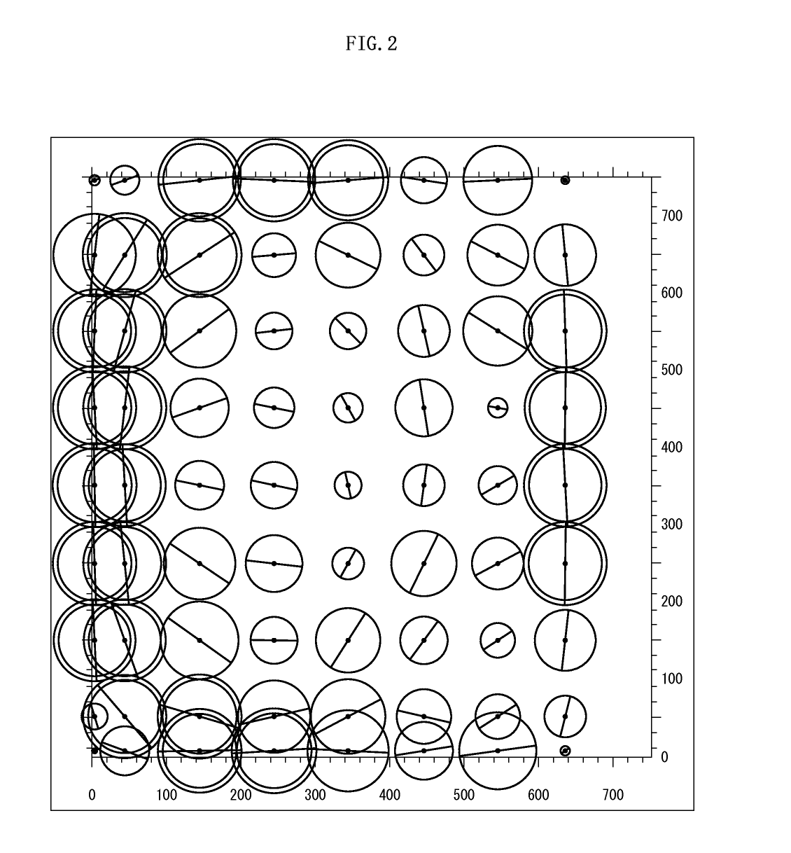

The maximum value of a retardation of the glass sheet to be tempered (original sheet) is a maximum value in an effective surface measured at an interval of 50 mm and is a value measured with a common optical path interferometric gauge using an optical heterodyne method and a birefringence measurement device using a Fourier analysis method, manufactured by Uniopt Co., Ltd. FIG. 1 is a diagram for showing measurement data on a retardation of an original sheet of Sample No. 1. FIG. 2 is a diagram for showing measurement data on a retardation of an original sheet of Sample No. 2. In FIG. 1 and FIG. 2, the center of each circle represents a measurement point, the diameter of each circle represents the magnitude of a retardation, and the direction of a line drawn as the diameter of each circle represents an azimuth angle θ of a retardation with respect to a side direction of a glass sheet. A warpage level was measured by placing the tempered glass sheet on a surface plate and detecting an effective surface on an upper side with a sensor while causing air to flow.

Next, each sample was immersed in a KNO₃ molten salt at 440° C. for 6 hours so as to be subjected to ion exchange treatment. Then, the surface of each sample was washed to produce a tempered glass sheet (original sheet size).

Separately, the warpage level of a piece of a tempered glass sheet was also measured. A glass sheet to be tempered (original sheet) was cut to collect 18 pieces of a 7-inch size (114.8 mm×176.4 mm) from an effective surface. Next, each piece sample was immersed in a KNO₃ molten salt at 440° C. for 6 hours so as to be subjected to ion exchange treatment. Then, the surface of each piece sample was washed to produce a piece of a tempered glass sheet. Then, the piece of the tempered glass sheet thus obtained was placed by being put up diagonally and scanned with a laser. Thus, the ratio of warpage with respect to the width of scanning was calculated. Each warpage level in Table 1 is an average value of the warpage levels of the pieces of the tempered glass sheet. It should be noted that the glass sheet to be tempered before ion exchange treatment was also evaluated for warpage in the same way.

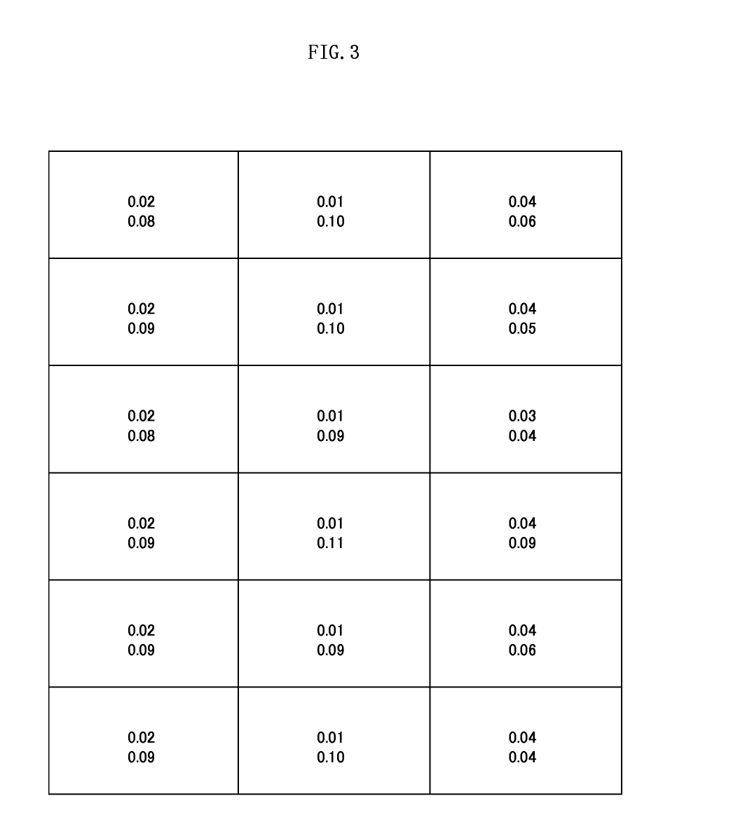

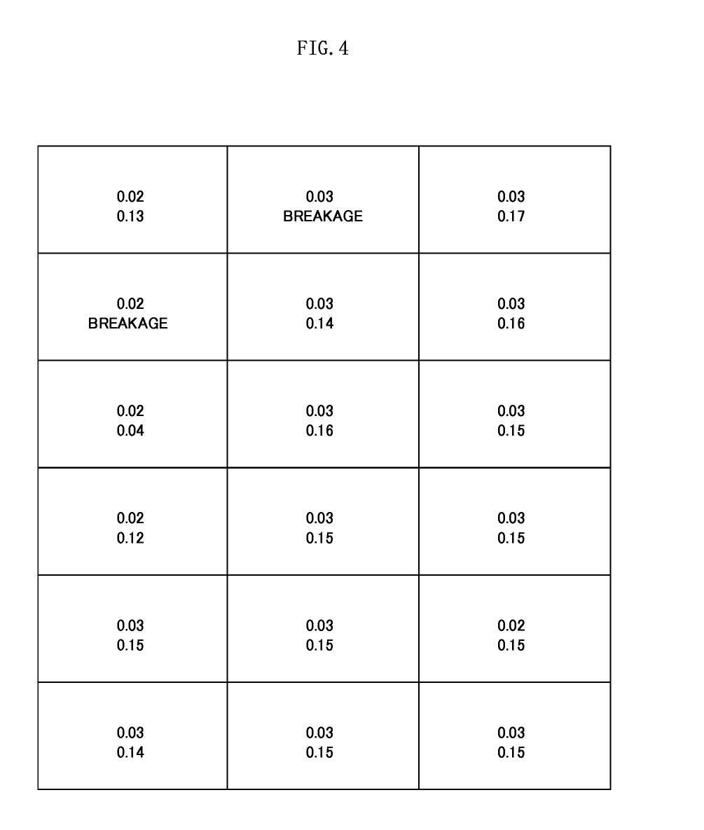

FIG. 3 is a diagram for showing data on a warpage level of each piece of Sample No. 1. FIG. 4 is a diagram for showing data on a warpage level of each piece of Sample No. 2. In FIG. 3 and FIG. 4, each numerical value in an upper stage represents a warpage level before ion exchange treatment, and each numerical value in a lower stage represents a warpage level after ion exchange treatment. It should be noted that, in FIG. 3 and FIG. 4, the collection position from the effective surface of the glass sheet to be tempered (original sheet) is shown for each section. Further, the direction in which a glass ribbon having flowed down during forming is a direction from an upper portion to a lower portion of FIG. 3 and FIG. 4.

Then, the compressive stress of a compressive stress layer on a surface and the depth of layer thereof were calculated on the basis of the number of interference fringes observed when a sample is observed using a surface stress meter (“FSM-6000” manufactured by Orihara Industrial Co., Ltd.) and intervals therebetween. For calculation, the refractive index of each sample was set to 1.52, and the optical elastic constant thereof was set to 28[(nm/cm)/MPa].

As is apparent from Table 1, in Sample No. 1, the maximum value of a retardation was small, and hence the warpage level after ion exchange treatment was small. Meanwhile, in Sample No. 2, the maximum value of a retardation was large, and hence the warpage level after ion exchange treatment was large.

It should be noted that, as the sheet area is larger, the warpage level increases, and as the sheet thickness is smaller, the warpage level increases. Thus, it is considered that, as the sheet area is larger or the sheet thickness is smaller, the significance of controlling the maximum value of a retardation in the effective surface to a predetermined value or less increases. Then, the tendencies of the maximum value of a retardation in the effective surface and the warpage level are considered to be the same also in glasses to be tempered (Sample Nos. 3 to 7) shown in Table 2.

TABLE 2

| | | No. 3 | No. 4 | No. 5 | No. 6 | No. 7 |
|---|---|---|---|---|---|---|
| Glass | SiO₂ | 66.0 | 58.8 | 61.7 | 61.19 | 62.4 |
| composition | Al₂O₃ | 14.2 | 21.4 | 19.7 | 16.2 | 12.9 |
| (mass %) | B₂O₃ | 2.3 | 4.9 | 3.6 | 0.8 | 2.0 |
| | Li₂O | 0.1 | — | — | — | 0.1 |
| | Na₂O | 13.4 | 13.1 | 13.2 | 14.1 | 16.0 |
| | K₂O | 0.6 | — | — | 3.4 | 2.0 |
| | MgO | 3.0 | 1.5 | 1.5 | 3.6 | — |
| | CaO | — | — | — | 0.5 | 2.0 |
| | ZrO₂ | — | 0.1 | 0.1 | 0.01 | 2.5 |
| | SnO₂ | 0.4 | 0.2 | 0.2 | 0.2 | 0.1 |

### Example 2

First, glass raw materials were blended to produce a glass batch so as to comprise as a glass composition, in terms of mass %, 60.5% of SiO₂, 20.5% of Al₂O₃, 2.3% of MgO, 16.0% of Na₂O, and 0.5% of SnO₂. Next, the glass batch was loaded into a continuous fusion furnace and formed into a sheet shape by an overflow down-draw method after a fining step, a stirring step, and a supply step. Then, the resultant was cut into dimensions of 1,800 mm×1, 500 mm×0.5 mm (thickness) to produce glass sheets to be tempered (original sheets). It should be noted that the generation of a rising air flow was suppressed by controlling the temperature distribution between the respective heaters within ±1° C. and controlling the atmospheric pressure of an external atmosphere of a forming furnace and an annealing furnace to be high during forming and annealing.

The glass sheet to be tempered thus obtained was measured for a maximum value of a retardation by the same method as above, and as a result, the maximum value was 0.80 nm. Then, the glass sheet to be tempered thus obtained was immersed in a KNO₃ molten salt at 430° C. for 4 hours so as to be subjected to ion exchange treatment. Then, a compressive stress of a compressive stress layer and a depth of layer thereof were calculated by the same method as above. As a result, the compressive stress was 1,220 MPa, and the depth of layer was 38 μm. It should be noted that, in the calculation, the refractive index and optical elastic constant of each sample were defined as 1.50 and 30 [(nm/cm)/MPa], respectively.

Further, a scribe line was formed on a surface of the obtained tempered glass sheet, and the tempered glass sheet was bent and split along the scribe line so that the tempered glass sheet was divided into 100 pieces each having a 7-inch size (114.8 mm×176.4 mm) from an effective surface. As a result, 100 pieces of the tempered glass sheet were able to be collected without breakage failure. It should be noted that, in the formation of the scribe line, scribing was performed so as to end in a region on an inner side by 5 mm or more from an opposing end surface. Further, in the scribe cutting, the depth of the scribe line was set to be larger than the depth of layer.

### INDUSTRIAL APPLICABILITY

The glass sheet to be tempered and the tempered glass sheet of the present invention are suitable for a cover glass of a display device, such as a cellular phone, a digital camera, or a PDA. Further, the glass sheet to be tempered and the tempered glass sheet of the present invention can be expected to find use in applications requiring a high mechanical strength, for example, a window glass, a substrate for a magnetic disk, a substrate for a flat panel display, a cover glass for a solid image pick-up element, and tableware, in addition to the above-mentioned applications.

1. A glass sheet to be tempered having a sheet area of 0.01 m² or more and a sheet thickness of 1.5 mm or less, wherein the glass sheet to be tempered has a maximum value of a retardation in an effective surface measured at an interval of 50 mm of 5.0 nm or less.

2. The glass sheet to be tempered according to claim 1, wherein the glass sheet to be tempered is formed by an overflow down-draw method.

3. The glass sheet to be tempered according to claim 1, wherein the glass sheet to be tempered has a content of B₂O₃ in a glass composition of from 0.7 mass % to 15 mass %.

4. The glass sheet to be tempered according to claim 1, wherein the glass sheet to be tempered has a content of Na₂O in a glass composition of from 1 mass % to 20 mass %.

5. The glass sheet to be tempered according to claim 1, wherein the glass sheet to be tempered comprises as a glass composition, in terms of mass %, 50% to 80% of SiO₂, 5% to 25% of Al₂O₃, 0.7% to 15% of B₂O₃, 1% to 20% of Na₂O, and 0% to 10% of K₂O.

6. The glass sheet to be tempered according to claim 1, wherein the glass sheet to be tempered has a compressive stress of a compressive stress layer on a surface of 400 MPa or more, and a depth of layer of the compressive stress layer of 15 μm or more, when subjected to ion exchange treatment in a KNO₃ molten salt at 440° C. for 6 hours.

7. The glass sheet to be tempered according to claim 1, wherein the glass sheet to be tempered has an unpolished surface.

8. The glass sheet to be tempered according to claim 1, wherein the glass sheet to be tempered is used for a cover glass of a display device.

9. A tempered glass sheet, which is produced by subjecting a glass sheet to be tempered to ion exchange treatment, wherein the glass sheet to be tempered comprises the glass sheet to be tempered of claim 1.

10. A method of manufacturing a tempered glass sheet, comprising subjecting the glass sheet to be tempered of claim 1 to ion exchange treatment and then cutting the glass sheet to be tempered.

11. A method of manufacturing a tempered glass sheet, comprising cutting the glass sheet to be tempered of claim 1 and then subjecting the glass sheet to be tempered to ion exchange treatment.

12. The glass sheet to be tempered according to claim 2, wherein the glass sheet to be tempered has a content of B₂O₃ in a glass composition of from 0.7 mass % to 15 mass %.

13. The glass sheet to be tempered according to claim 2, wherein the glass sheet to be tempered has a content of Na₂O in a glass composition of from 1 mass % to 20 mass %.

14. The glass sheet to be tempered according to claim 3, wherein the glass sheet to be tempered has a content of Na₂O in a glass composition of from 1 mass % to 20 mass %.

15. The glass sheet to be tempered according to claim 12, wherein the glass sheet to be tempered has a content of Na₂O in a glass composition of from 1 mass % to 20 mass %.

16. The glass sheet to be tempered according to claim 2, wherein the glass sheet to be tempered comprises as a glass composition, in terms of mass %, 50% to 80% of SiO₂, 5% to 25% of Al₂O₃, 0.7% to 15% of B₂O₃, 1% to 20% of Na₂O, and 0% to 10% of K₂O.

17. The glass sheet to be tempered according to claim 3, wherein the glass sheet to be tempered comprises as a glass composition, in terms of mass %, 50% to 80% of SiO₂, 5% to 25% of Al₂O₃, 0.7% to 15% of B₂O₃, 1% to 20% of Na₂O, and 0% to 10% of K₂O.

18. The glass sheet to be tempered according to claim 4, wherein the glass sheet to be tempered comprises as a glass composition, in terms of mass %, 50% to 80% of SiO₂, 5% to 25% of Al₂O₃, 0.7% to 15% of B₂O₃, 1% to 20% of Na₂O, and 0% to 10% of K₂O.

19. The glass sheet to be tempered according to claim 12, wherein the glass sheet to be tempered comprises as a glass composition, in terms of mass %, 50% to 80% of SiO₂, 5% to 25% of Al₂O₃, 0.7% to 15% of B₂O₃, 1% to 20% of Na₂O, and 0% to 10% of K₂O.

20. The glass sheet to be tempered according to claim 13, wherein the glass sheet to be tempered comprises as a glass composition, in terms of mass %, 50% to 80% of SiO₂, 5% to 25% of Al₂O₃, 0.7% to 15% of B₂O₃, 1% to 20% of Na₂O, and 0% to 10% of K₂O.
